(19) United States
(12) Patent Application Publication
(10) Pub. No.: US 2019/0293821 A1
(43) Pub. Date: Sep. 26, 2019

(54) AUTOMATED NODE STORAGE AND RETRIEVAL SYSTEM WITH SHAPED RECEPTACLES

(71) Applicant: ION Geophysical Corporation, Houston, TX (US)

(72) Inventors: Timothy A. Dudley, Houston, TX (US); Paul Brettwood, Sunderland (GB); Darrell Burch, West Columbia, TX (US); Jeff Waegelin, Fishers, IN (US); John Swinford, Indianapolis, IN (US)

(21) Appl. No.: 16/361,944

(22) Filed: Mar. 22, 2019

Related U.S. Application Data
(60) Provisional application No. 62/647,247, filed on Mar. 23, 2018.

(51) Int. Cl. G01V 1/38; G01V 13/00

(52) U.S. Cl. CPC G01V 1/3843; G01V 13/00

(57) ABSTRACT

An automated storage and retrieval system for seismic nodes includes a modular housing having a first row of rack structures and a second row of rack structures. The system further includes a first receptacle configured to couple a sensor module of a seismic node to a rack structure of the first row of rack structures for storage and reconditioning of the sensor module, and a second receptacle configured to couple a power source module of the seismic node to a rack structure of the second row of rack structures for storage and reconditioning of the power source module.

### CROSS-REFERENCE TO RELATED APPLICATIONS

This application claims priority to U.S. Provisional Patent Application No. 62/647,247, filed Mar. 23, 2018, entitled “Automated Nodestorage and Retrieval System Including Molded Receptacles,” which is incorporated by reference herein, in the entirety and for all purposes.

### BACKGROUND

This application relates generally to geophysical exploration, and more specifically to seismic data acquisition and sensor technologies. In particular, the application relates to sensor systems for marine seismic surveys, including, but not limited to, ocean bottom cables, autonomous seismic nodes, and towed node systems.

Petrochemical products are ubiquitous in the modern economy, and can be found in everything from oil and gasoline to medical devices, children's toys, and a wide range of everyday household items. To meet the continuing demand for these products, oil and gas reserves must be accurately located and surveyed, so that these important resources can be effectively managed. As a result, there is an ongoing need for new seismic sensor systems and more advanced exploration technologies.

Scientists and engineers typically utilize seismic wave-based exploration to locate new oil and gas reservoirs, and to survey and manage existing reserves over time. Seismic surveys are performed by deploying an array of seismic sensors or receivers over the region of interest, and monitoring the response to controlled emission of seismic energy via a seismic source such as a vibrator, air gun array, or explosive detonation. The response depends upon the seismic energy reflected from mineral reservoirs and other subsurface formations, allowing an image of the corresponding structures to be generated.

Conventional marine seismic surveys typically proceed by towing an array of seismic sensors or receivers behind a survey vessel, with the receivers distributed along one or more streamer cables. A set of air guns or other seismic sources is used to generate the seismic energy, which propagates down through the water column to penetrate the ocean floor (or other bottom surface). A portion of the seismic energy is reflected from subsurface structures, and returns through the water column to be detected in the streamer array. Alternatively, seismic receivers can also be disposed along an ocean-bottom cable, or provided in the form of individual, autonomous seismic nodes distributed on the seabed.

Seismic receivers include both pressure sensors and particle motion detectors, which can be provided as individual sensor components or combined together with both sensor types provided in close proximity within a receiver module or seismic node. For example, a set of pressure sensors can be configured in a hydrophone array, and adapted to record scalar pressure measurements of the seismic wavefield propagating through the water column or other seismic medium. Particle motion sensors include accelerometers and geophones, which can provide single-axis or three-dimensional vector velocity measurements that characterize motion of the medium in response to propagating seismic waves.

Geophysical data pertaining to subsurface structures is acquired by observing the reflected seismic energy with an array of such receiver components. The resulting seismic signals can be used to generate an image characterizing the subsurface composition and geology in and around the survey area.

### SUMMARY

This application is directed to an automated storage and retrieval system (ASRS) for modular seismic nodes, which can be used to collect seismic data for geophysical exploration. The system may include receptacles configured to couple with individual sensor and power source modules for storage and reconditioning. The receptacles can be shaped or molded to engage with the respective modules.

The modular seismic nodes (or autonomous node assemblies) can be configured for deployment to a water column or other medium, through which seismic waves propagate. In some examples, the seismic nodes include a sensor module with a seismic sensor for acquiring seismic data and a seismic data store for storing the data, and a power source module with a power source for powering the sensor module.

For example, the sensor module can include an elongate lobe or axial section extending from a base or frame component, with at least one seismic sensor configured to generate seismic data responsive to the seismic waves or wavefield. The power source module (or power module) can include one or more elongate lobes or longitudinal sections extending from a second base or frame component, with at least one power source configured to provide power to the sensor module for operation of the seismic sensor. For deployment, the sensor and power modules are coupled together (e.g., in an axial or longitudinal engagement with the axial section of the sensor module disposed between first and second longitudinal sections of the power module).

While being stored and reconditioned, the sensor modules can be separated from the power modules, and stored in different receptacles coupled to different rack structures. The module receptacles or mounts can be shaped or molded of a polymer or composite material, or otherwise formed to provide suitable geometry, and arranged in an array of rows and columns on rack structures within a modular housing unit (e.g., a shipping container or other standardized enclosure or structure). For example, the receptacles can be installed along longitudinal rack structures within the housing (e.g., with the receptacles or module mounts fixed to vertical pillar or column structures, or horizontal rack structures). The first set of receptacles can be shaped or molded with a base and longitudinal extensions having a first geometry configured to couple with the sensor module or sensor section of the node assembly, and a second set of receptacles can be shaped or molded with a base and longitudinal extensions having a second geometry configured to couple with the power modules or power sections of the node assembly.

Installation of the receptacles within the housing may include fixing the receptacles to the respective rack structures, with suitable connections to a power source and data transfer bus adapted to retrieve data and recondition the sensor and power source modules. The modular housing can be installed on a vessel, and connected to suitable power and data networks for charging and reconditioning the modules. The system can also include a node handling apparatus configured to disassemble the modular seismic nodes into individual sensor and power module components, and to couple sensor and power modules together to form assembled seismic nodes.

This summary is provided to introduce a selection of related technical concepts, which are further described in the detailed description. The summary is not intended to identify key advantages or essential features of the invention, nor to limit the scope of the claims. A more detailed presentation of additional features, details, utilities, and advantages of the claimed subject matter is provided in the following written description, including various representative examples and embodiments of the invention, and as illustrated in the accompanying drawings.

### BRIEF DESCRIPTION OF THE DRAWINGS

FIG. 1 is a perspective view of an automated storage and retrieval system for seismic nodes, according to embodiments of the present disclosure.

FIG. 2A is a perspective view of a seismic node storage and retrieval system according to the present disclosure.

FIG. 2B is a top-down view of a seismic node storage and retrieval system, according to the present disclosure.

FIG. 3A is an isometric view of a modular seismic node assembly, with the sensor module disengaged from the power module, according to some embodiments of the disclosure.

FIG. 3B is an isometric view of the seismic node assembly with sensor and power modules engaged inside a jacket or housing, according to embodiments of the disclosure.

FIG. 4 is an isometric view of a receptacle for coupling with the sensor module or seismic node assembly.

FIG. 5 is an isometric view of a single receptacle for coupling with a power module or seismic node assembly.

### DETAILED DESCRIPTION

In the following, reference is made to embodiments of the invention. It should be understood, however, that the invention is not limited to the specifically described embodiments. Any combination of the following features and elements, as described in terms of the various embodiments, is contemplated to implement and practice the invention.

Although various features of the invention may provide advantages over the prior art, and over other possible solutions to the problems address herein, whether or not such advantages are achieved does not limit the invention to a given embodiment. The following aspects, features and advantages of the invention are merely illustrative, and are not considered elements or limitations of the appended claims, except where explicitly recited therein. Likewise, reference to “the invention” shall not be construed as a generalization of any subject matter disclosed herein, and does not limit the claims except where expressly included.

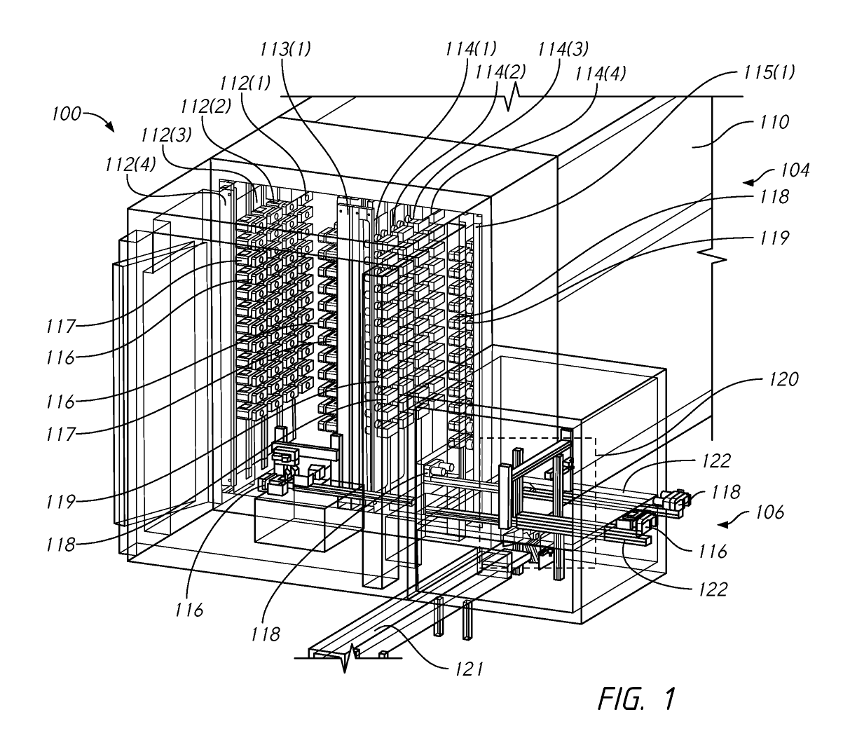

FIG. 1 is a perspective view of an automated storage and retrieval system (ASRS) 100 according to embodiments of the present disclosure. The system 100 may include a storage and reconditioning subsystem or apparatus 104 and a node handling subsystem or apparatus 106. The storage and reconditioning apparatus 104 may include a housing 110 that includes longitudinal rack structures 112(1)-(N) and 113(1)-(N) having arrays (e.g., rows and columns) of receptacles 117 each configured to couple with or affix to and store respective sensor modules 116. The housing 110 may further include longitudinal rack structures 114(1)-(N) and 115(1)-(N) having arrays of receptacles 119 each configured to affix to and store respective powers source modules 118. Each of the longitudinal rack structures 112(1)-(N) and 113(1)-(N) may include multiple of the receptacles 117 arranged in a column, and each of the longitudinal rack structures 114(1)-(N) and 115(1)-(N) may include receptacles 119. Individual ones of the 116 and the 118 may be coupled together to form a single modular seismic node assembly. The number if longitudinal rack structures in a particular row of longitudinal rack structures may be determined by a length of the housing 110 and spacing between individual longitudinal rack structures. Without departing from the scope of the disclosure, each of the individual the longitudinal rack structures 112(1)-(N), 113(1)-(N), 114(0)-(N), and 115(1)-(N) may be oriented a lateral direction extending from a first end to a second end of the housing 110, rather than being oriented in a vertical direction within the housing 110.

The receptacles 115, 119 may be affixed to the respective longitudinal rack structures 112(1)-(N), 113(1)-(N), 114(1)-(N), and 115(1)-(N) and may be configured to couple with the sensor module 116 or the power source module 118, respectively. For example, the receptacles 117 may be a first type that are configured to couple with the sensor modules 116 and the receptacles 119 may be a second type that are configured to couple with the power source modules (or power modules) 118. The receptacles 115, 119 may be configured to secure the respective sensor modules 116 and power modules 118 for storage and transport. The receptacles 115, 119 may be further configured to recondition the sensor modules 116 and the power modules 118. Reconditioning of the sensor modules 116 may include retrieving seismic data from memory of the sensor modules 116, recalibrating sensors of the sensor modules 116, recalibrating clocks of the sensor modules 116, or combinations thereof. Reconditioning of the power modules 118 may include charging of power sources, testing power sources, recalibrating power sources, or combinations thereof. The receptacles may allow for more secure and denser storage of the sensor modules 116 and the power modules 118 as compared with storage systems that use shelves.

The node handling apparatus 106 can include a modular node assembly/disassembly mechanism 120 configured to assemble modular seismic nodes from the sensor modules 116 and the power modules 118, and to disassembly the nodes into the sensor modules 116 and power modules 118. The assembly/disassembly mechanism 120 includes robotic arms, pushers or similar components for selectively engaging and disengaging the sensor and power modules, and a linear or screw actuator configured to couple and decouple the sensor and power modules 116, 118, for example via a coupling pin, screw, or other mechanical attachment. The node handling apparatus 106 can be connected to tracks 121 to transport the assembled modular seismic nodes to and from the node handling apparatus 106, and tracks 122 to transport the sensor modules 116 and power modules 118 to and from the storage and reconditioning apparatus 104.

In operation, nodes storage system 100 receives modular seismic node assemblies for storage and reconditioning, e.g., following recovery of the modular seismic node assemblies after seismic data acquisition in a seismic survey. The node assembly/disassembly mechanism 120 of the node handling apparatus 106 separates each of the modular seismic node assemblies into an individual sensor modules 116 and an individual power modules 118. The node handling apparatus 106 sends the individual sensor modules 116 and individual power modules 118 along tracks 122 to the storage and reconditioning apparatus 104. The sensor modules 116 and the power modules 118 are each coupled to a respective receptacle 115, 119 mounted on the longitudinal rack structures 112(1)-(N), 113(1)-(N), 114(1)-(N), and 115(1)-(N) of the housing 110. When coupled to the receptacles 115, 119, the sensor modules 116 and the power modules 118 may be reconditioned and stored, including retrieving collected data, recalibrating sensors and clocks, and charging power sources.

During a deployment, the system 100 provides the sensor modules 116 and the power modules 118 from the housing 110 by retrieving the sensor modules 116 and the power modules 118 from the respective receptacle mounted on the longitudinal rack structures 112(1)-(N), 113(1)-(N), 114(1)-(N), and 115(1)-(N) of the housing 110. The separated sensor modules 116 and power modules 118 are provided to the node handling apparatus 106. The node assembly/disassembly mechanism 120 assembles pairs of the sensor modules 116 and power modules 118 into complete (e.g., self-contained) modular seismic node devices. The system 100 using the receptacles 115, 119 for storing and reconditioning the sensor modules 116 and the power modules 118 may provide a more secure, more safe, and more dense storage system as compared with a storage and reconditioning system that stores the sensor modules 116 and the power modules 118 on shelves.

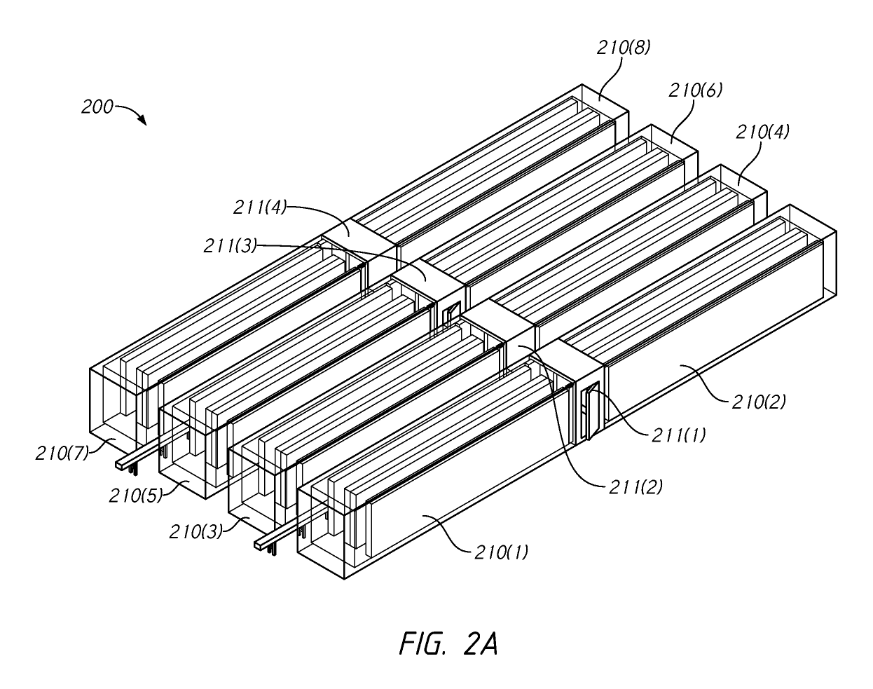

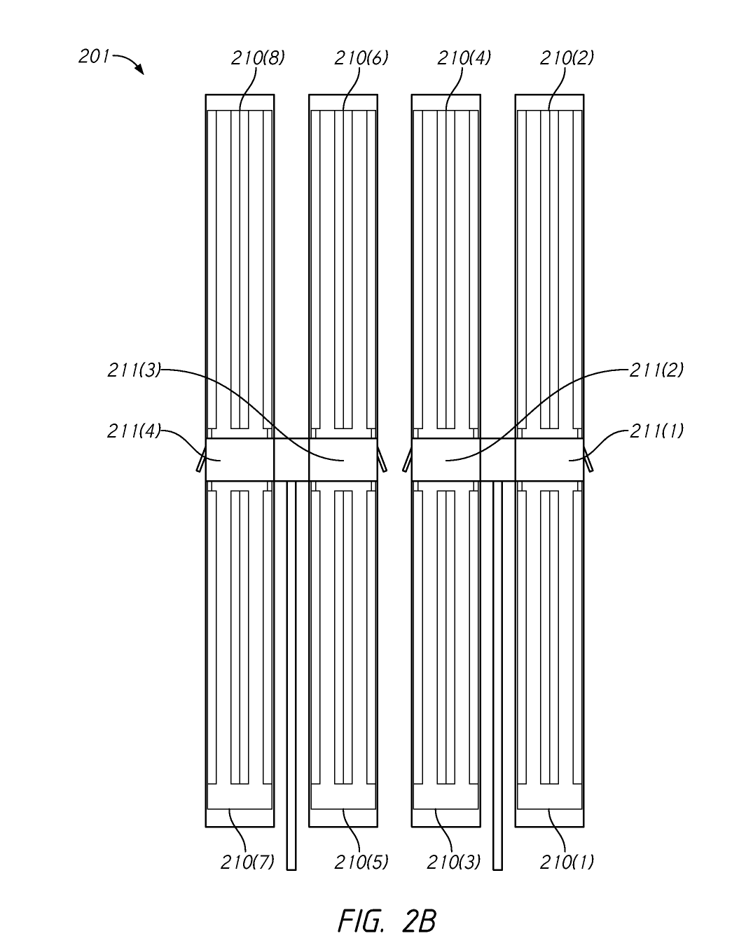

FIG. 2A is a perspective view of an automated seismic node storage and retrieval system 200 according to the present disclosure, and FIG. 2B is a top-down view of the storage and retrieval system 200. As shown in FIGS. 2A and 2B, the system 200 includes a number of modular housing units 210(1)-(8) and node assembly/disassembly subsystems 211(1)-(4). The modular housing units 210(1)-(8) may be separated into pairs adjoined end to end; for example, one or more of a first pairs of housing units 210(1) and 210(2) arranged end-to-end, a second pair of housing units 210(3) and 210(4) arranged end-to-end, a third pair of housing units 210(5) and 210(6) arranged end-to-end, and a fourth pair of housing units 210(7) and 210(8) arranged end-to-end.

Each of the node assembly/disassembly subsystems 211(1)-(4) is disposed between a respective one of the end-to-end pairs of modular housing units 210(1)-(8). Each of the housing units 210(1)-(8) may include a housing structure 110 as shown in FIG. 1. Each of the assembly/disassembly systems 211(1)-(4) may include a node handling apparatus 106 as shown in FIG. 1. Each of the housing units 210(1)-(8) are configured to store arrays of sensor modules (e.g., such as the sensor modules 116 of FIG. 1) using receptacles (e.g., such as the receptacles 117 of FIG. 1) and to store arrays of power modules (e.g., such as the power modules 118 of FIG. 1) using receptacles (e.g., such as the receptacles 119 of FIG. 1).

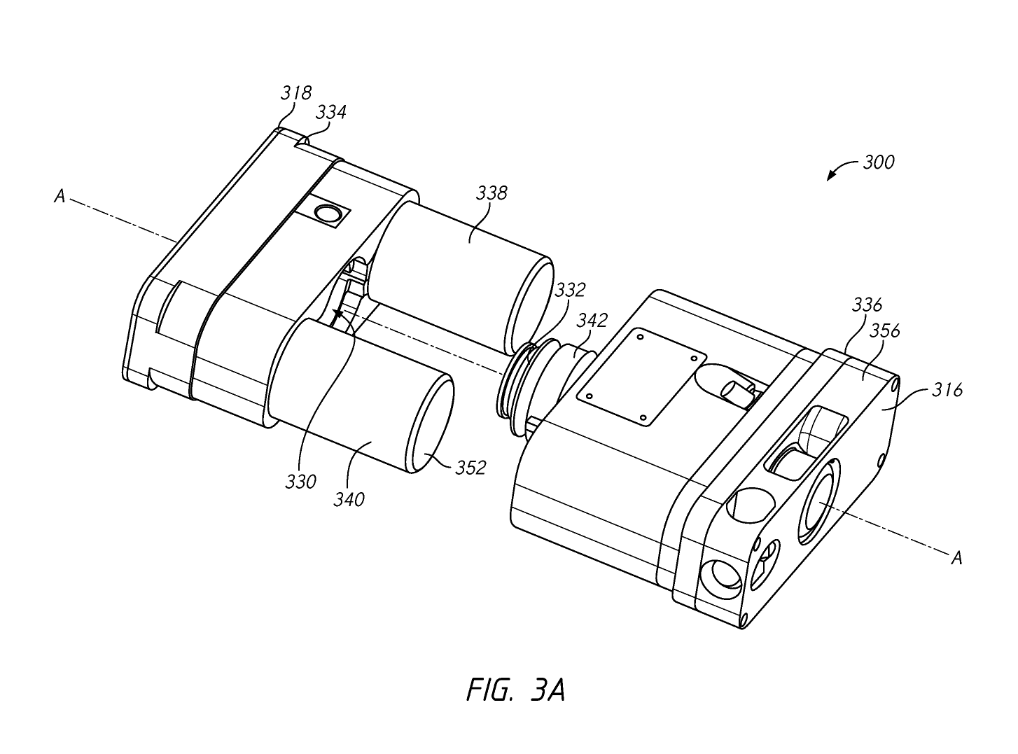

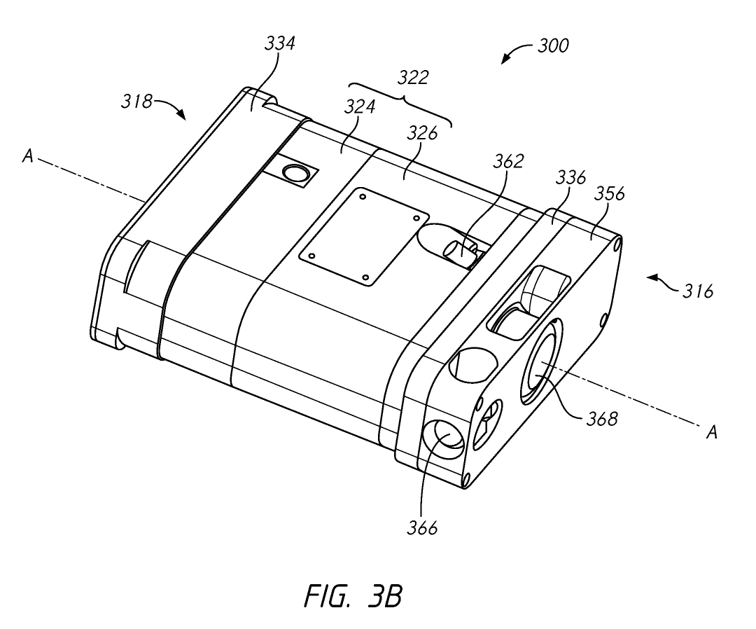

FIG. 3A is an isometric view of a single modular seismic node assembly 300, with a sensor module 316 disengaged from a power source module (or power module) 318, according to some embodiments of the disclosure. As shown by FIG. 3A, the modular seismic node assembly 300 can be assembled by selectively coupling the sensor module 316 and the power module 318 together, e.g., in an axial or longitudinal engagement with the axial section 342 of the sensor module 316 disposed along a principal longitudinal axis A of the modular seismic node assembly 300, between the first and second longitudinal, laterally disposed sections 338, 340 of the power module 318. One or more of the sensor modules 116 of FIG. 1 may implement the sensor module 316, and one or more of the power modules 118 of FIG. 1 may implement the power module 318.

The sensor module 316 includes an outer cover or housing component 356 that can be provided to cover and protect the exterior-facing sensor module components, and to improve hydrodynamic properties. The sensor module 316 includes a frame structure 336 extending transversely with respect to the longitudinal axis A and a central sensor section 342 that extends longitudinally from the sensor module frame structure 336, along the central axis A, with seismic motion sensors housed inside. The axial section 342 of the sensor module 316 may be integrally formed with the sensor module frame 336, or they can be formed separately and mechanically attached. The frame 336 of the sensor module 316 may have a height and width approximately similar to or substantially the same as that of a power module base 334, in order to provide a substantially symmetrically dimensioned modular seismic node assembly 300. For example, the axial section 342 may extend longitudinally along the central axis A, approximate from the middle of the sensor module frame structure 336, so that the axial section 342 is symmetrically disposed between the longitudinal sections 338, 340 of the power module 318.

Structurally, the power module 318 may include a base or frame component 334 extending generally transversely to the longitudinal axis A of the modular seismic node assembly 300, between the longitudinal sections 338, 340. The power module sections 338, 340 extend longitudinally from the base or chassis 334, e.g., generally parallel to the principal axis A, and transversely disposed on either side of the axial section 342 of the sensor module 316. In some embodiments, additional components of the power module 318, such as battery memory board, may be mounted on the base 334, e.g., between the first and second longitudinal sections 338, 340. A power module connector extends from the base or frame 334 along axis A, between the laterally disposed sections 338, 340 within the receiving aperture 330.

When deployed on a seabed or other surface S, the axial section 342 of the sensor module 316 and the longitudinal power module sections 338, 340 may be arranged in a generally horizontal plane, with the longitudinal sections 338, 340 of the power module 302 disposed on opposing lateral sides of the modular seismic node assembly 300, and with the first and second base components on opposite ends of the longitudinal axis.

The modular seismic node assembly 300 can be disassembled by selectively disengaging or decoupling the power module 318 from the sensor module 316, e.g., following recovery of the modular seismic node assembly 300 after seismic data acquisition in a seismic survey. In some embodiments, the sensor module 316 can be decoupled from the power module 318 by sliding the axial section 342 of the sensor module 316 out from between the laterally disposed sections 338, 340 of the power module 318, disengaging the modules 316 and 318 along the primary axis A of the modular seismic node assembly 300.

The longitudinal power module sections 338, 340 form housings for the respective power source components of the power module 318, and the central sensor section 342 forms a housing for the modular seismic node assembly 300. When the power module 318 and sensor module 316 are selectively engaged or coupled together, the power module 318 can be electrically connected to the sensor module 316, with one or more battery packs, power assemblies, or other individual power sources configured to provide operational power to the seismic motion sensors of the sensor module 316 and other internal sensor module components.

For example, a data recorder system can also be provided in the sensor module 316, and configured for recording seismic data collected by the seismic motion sensor(s) and acoustic pressure sensor, and other sensor devices. Suitable seismic data recorder systems may also include a data acquisition board or circuit with a combination of random access memory and non-volatile (or non-transient) data storage media with sufficient capacity to record the substantial amounts of seismic data that may be obtained during a seismic survey. The data recorder system may also include a timing device or clock circuit. In some embodiments, the timing circuit or clock can be configured to independently generate a clock signal for the seismic sensor station, where the clock signal is associated with the acquired seismic data for storage in the data recorder system. For example, the timing device or clock may incorporate a chip scale atomic clock (CSAC) or similar highly accurate clock component. In some embodiments, the timing device or clock may be configured to receive an external clock signal from a master clock, and to generate a local or slave clock signal that is synchronized with the external master clock signal to provide improved timing accuracy for the seismic data acquired by the modular seismic node assembly 300.

In some embodiments a transponder can be provided for external communications, e.g., with a remote processor or control system on board a seismic vessel, or on a surface buoy or unmanned autonomous vessel. For example, a suitable acoustic or wireless transponder 118 may be configured to communicate information indicative of the position, orientation, and operational condition of a seismic node system, such as the location, tilt, and power condition of the modular seismic node assembly 300. Alternatively or in combination, transponder can also be configured for peer-to-peer communications with other modular seismic node assemblies 300 deployed in a seismic survey.

An antenna, such as a radio frequency (RF) antenna or other wireless transmitter or transceiver 362, can be provided and coupled to the power module 318 or sensor module 316, and configured to communicate with the modular seismic node assembly 300. The antenna or wireless transmitter 362 can derive power from the power module 318 with the modular seismic node assembly 300 coupled together, and communicate data and/or control information between the modular seismic node assembly 300 and a survey control or data collection system, e.g. on board a seismic vessel. For example, the antenna 362 can be used to communicate commands for the modular seismic node assembly 300 to power on and off, by transmitting RF signals to the antenna 362 In some embodiments, the antenna 362 communicates a time stamp or other clock information with the internal clock inside the modular seismic node assembly 300, for example a timing signal used for clock synchronization or for correction of clock drift. More generally, the RF antenna or wireless transceiver 362 can be used for communicating any suitable data and/or selected commands to and from the respective internal component of each modular seismic node assembly 300.

In some embodiments, a coupling or connector 332 extends from the axial section 342 of the sensor module 316, and is configured to selectively engage with a complementary mating connector extending from the base 334 of the power module 318, inside receiving aperture 330. Depending on application, the power module connector can be provided with a jack or similar power module interface configured to connect with a complementary sensor module interface inside the sensor module connector 332, in order to form electrical connections between the power sources of the power module 318 and the various internal electronic components of the sensor module 316. Suitable mechanical connectors 330 and 332 may also provide water-tight and pressure tight connections between the power module 318 and the sensor module 318, in order to protect the internal components from seawater, pressure, dirt, and other potentially adverse operational effects and environmental conditions.

Structurally, the power module 318 may include a base or frame structure 334 extending generally transversely to the longitudinal axis A of the modular seismic node assembly 300, between the longitudinal sections 338, 340. The power module sections 338, 340 extend longitudinally from the base or chassis 334, e.g., generally parallel to the principal axis A, and transversely disposed on either side of the axial section 342 of the sensor module 316. The power module connector extends in the aperture 330 from the base or frame 334 along axis A, between the laterally disposed sections 338, 340.

FIG. 3B is an isometric view of the seismic node assembly 300 with the sensor module 316 and power module 318 engaged inside a jacket or housing assembly 322, according to alternate embodiments of the disclosure. Alternatively, the assembled node 300 can be provided in either modular or non-modular (integrated) form, for example with a suitable power section 316 assembled together with a suitable sensor section 318, or in either a decouplable (modular) or substantially permanently affixed (unitary) form of the node assembly 300.

Similarly, the jacket or housing 322 can be formed as a unitary component or with one or more individual sections 324, 326. For example, a first jacket section 324 can be disposed about the longitudinal power module sections 338, 340 of the power supply module 318, and a second jacket section 326 can be disposed about the axial sensor module section 342 of the sensor module 316 (see FIG. 3A). More generally, one or more separable or integrated sections 324, 326 of the jacket 322 can be arranged toward opposing ends of the seismic sensor node assembly 300.

Other components can also be included with assembly 300, for example one or more of a radio frequency or wireless transceiver 362, an acoustic pressure sensor 366, or an acoustic transponder 368. These additional components 362, 366, 368 can be mounted to either module 316 or 318, or to the assembled node 300, in communication with the exterior environment as shown. This arrangement provides for RF or wireless communications through the surrounding atmosphere using transceiver 362; e.g., when storing and staging the node assembly 300, and for acoustic communication via using hydrophone 366 and acoustic transponder 368; e.g., when the node assembly 300 is deployed to a water column or other seismic medium.

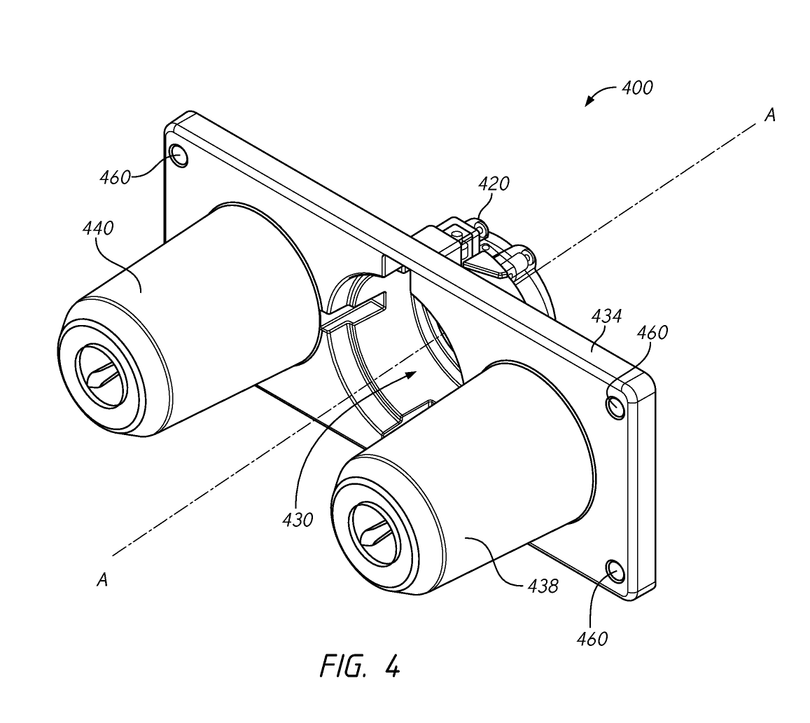

FIG. 4 is an isometric view of a single receptacle 400 for coupling with a sensor module. The receptacle 400 can be assembled by selectively coupling the sensor module 316 of FIG. 3A, e.g., in an axial or longitudinal engagement with the axial section 342 of the sensor module 316 disposed along a principal longitudinal axis A, between the first and second longitudinal, laterally disposed sections 438, 440 of the receptacle 400. Alternatively, a suitable receptacle 400 can be adapted for coupling to an assembled node 300 as shown in FIG. 3B; e.g., using a similar coupling arrangement on the exposed end or other external surface of the sensor section 316. The receptacles 117 of FIG. 1 may include the receptacle 400 for storing and reconditioning a connected sensor module.

Structurally, the receptacle 400 may include a base or frame component 434 extending generally transversely to the longitudinal axis A of the receptacle 400, between the longitudinal sections 438, 440. The base or frame component 434 includes holes 460 proximate to each corner for affixing the receptacle 400 to a longitudinal rack structure, such as one of the longitudinal rack structures 112(0)-(N) or the longitudinal rack structures 115(0)-(N) of FIG. 1. The holes 460 may align with respective holes on the longitudinal rack structure to which it is affixed. The receptacle 400 may be affixed to the longitudinal rack structure using an attachment means, such as a respective screw or bolt that extends through each hole 460 and the corresponding hole in the longitudinal rack structure. The longitudinal sections 438, 440 extend longitudinally from the base or chassis 434, e.g., generally parallel to the principal axis A, and transversely disposed on either side of the axial section 342 of the sensor module 316 when coupled. The connector 420 extends in the aperture 430 from the base or frame 434 along axis A, between the laterally disposed sections 438, 440.

The receptacle 400 can be selectively disengaged or decoupled from the sensor module 316, for example, when removed from an automated node storage system to be deployed or replaced. The sensor module 316 can be decoupled from the receptacle 400 by sliding the axial section 342 of the sensor module 316 out from between the laterally disposed sections 438, 440 of the receptacle 400, disengaging the sensor module 316 and from the receptacle 400 along the primary axis A.

The longitudinal receptacle sections 438, 440 form housings for the sensor module 316 to attach and secure itself to the receptacle 400. For example, when coupled, are the longitudinal receptacle sections 538, 540 are inserted into respective apertures of the sensor module 116. In some embodiments, a coupling or connector 332 extends from the axial section 342 of the sensor module 316, and is configured to selectively engage with a complementary mating connector 420 extending from the base 434 of the receptacle 400, inside receiving aperture 430. Depending on application, the mating connector 420 can be provided with a jack or similar power module interface configured to connect with the connector of the power module 318, in order to form electrical connections between the power sources and network of vessel and the various internal electronic components of the sensor module 316.

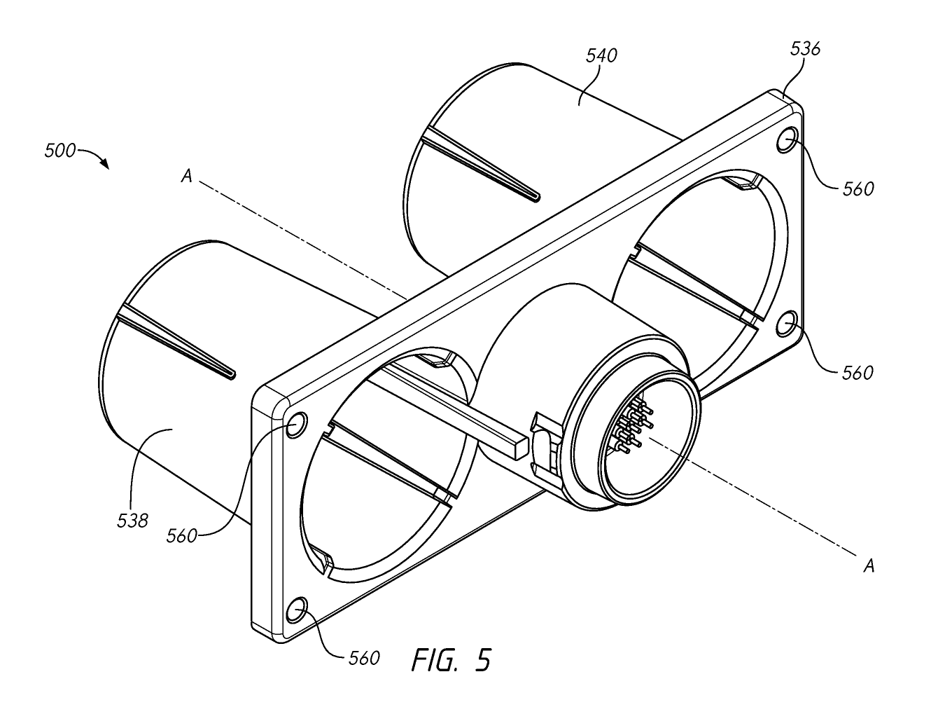

FIG. 5 is an isometric view of a single receptacle 500 for coupling with a power module. The receptacle 500 can be assembled by selectively coupling the power module 318 of FIG. 3, e.g., in an axial or longitudinal engagement with the power source connector in the aperture 330 of the power module 318 disposed along a principal longitudinal axis A, with the first and second longitudinal, laterally disposed sections 338, 340 of the power module 318 sliding inside the first and second longitudinal, laterally disposed sections 538, 540 of the receptacle 500. Alternatively, a suitable receptacle 500 can be adapted for coupling to an assembled node 300 as shown in FIG. 3B; e.g., using a similar coupling arrangement on the exposed end or other external surface of the power section 318. The receptacles 119 of FIG. 1 may include the receptacle 500 for storing and reconditioning a connected power module.

Structurally, the receptacle 500 may include a base or frame component 536 extending generally transversely to the longitudinal axis A of the receptacle 500, between the longitudinal sections 538, 540. The base or frame component 536 includes holes 560 proximate to each corner for affixing the receptacle 500 to a longitudinal rack structure, such as one of the longitudinal rack structures 113(0)-(N) or the longitudinal rack structures 114(0)-(N) of FIG. 1. The holes 560 may align with respective holes on the longitudinal rack structure to which it is affixed. The receptacle 500 may be affixed to the longitudinal rack structure using an attachment means, such as a respective screw or bolt that extends through each hole 460 and the corresponding hole in the longitudinal rack structure. The longitudinal sections 538, 540 extend longitudinally from the base or chassis 536, e.g., generally parallel to the principal axis A, and transversely disposed on either side of the axial section 542 of the receptacle 500. The connector 532 extends from the base or frame 536 along axis A, between the laterally disposed sections 538, 540.

The receptacle 500 can be selectively disengaged or decoupled from the power module 318, for example, when removed from an automated node storage system to be deployed or replaced. The power module 318 can be decoupled from the receptacle 500 by sliding the power module 318 away from the axial section 542 of the receptacle 500 between the laterally disposed sections 338, 340 of the power module 318, thereby disengaging the power module 318 and from the receptacle 500 along the primary axis A.

The longitudinal receptacle sections 538, 540 form housings for the laterally disposed sections 338, 340 of the power module 318 to attach and secure the power module 318 to the receptacle 500. For example, when coupled, the laterally disposed longitudinal sections 338, 340 of the power module 318 are inserted into the longitudinal receptacle sections 538, 540. The In some embodiments, a coupling or connector 532 extends from the axial section 542 of the receptacle 500, and is configured to selectively engage with a complementary mating connector in the receiving aperture 330 of the power module 318. Depending on application, the mating connector 532 can be provided with a jack or similar sensor module interface configured to connect with the connector of the sensor module 316, in order to form electrical connections between the power sources and network of vessel and the various internal electronic components of the power module 318.

The receptacles 400 and 500 of FIGS. 4 and 5 may be formed via a molding process including, but not limited to, an injection molding process, powder-molding process, or other manufacturing process designed to mirror or complement different respective physical coupling characteristics of the sensor module 316 and the power module 318, respectively. Suitable materials for receptacles 400 and 500 include durable polymers, metal alloys, composite materials, and combinations thereof. Use of the receptacles 400 and 500 within the automated node storage system 100 of FIG. 1 or the systems 200 of FIGS. 2A and 2B can provide more secure and higher density storage of sensor modules and power modules used to form modular seismic node assemblies of seismic surveys.

In any of the above examples and embodiments, the modular seismic node assembly coupling, the sensor module and receptacle coupling, or the power module and receptacle coupling can comprise an engagement feature or mechanism movably coupled to one of the power module, the sensor module, or one of the receptacles, e.g., with the engagement mechanism adapted to selectively engage the other of the power module, the sensor module, or one of the receptacles upon manual manipulation. The engagement mechanism can comprise a pin or similar member having a tapered barrel portion adapted to selectively engage and disengage with a groove or slot defined on the axial section of the sensor module.

Coupling the power module or the sensor module to one of the respective receptacles may include selectively engaging such a pin (or similar engagement member) with the axial section of the sensor module, the power module, or one of the receptacles. Selectively engaging the pin member with the axial section of the sensor module, the power module, or one of the receptacles can comprise axially positioning a barrel or middle portion of the pin member within a groove or slot defined on a perimeter of the axial section of the sensor module, the power module, or one of the receptacles.

### EXAMPLES

In various examples and embodiments, an automated storage system for seismic nodes includes a modular housing assembly with a first set of one or more rack structures arranged in a first row, and a second set of one or more rack structures arranged in a second row. A first set of one or more receptacles can be configured to couple seismic node sensor modules to the rack structures in the first row, and adapted for storage of and data communication with the sensor modules. A second set of one or more receptacles can be configured to couple seismic node power source modules to the rack structures in the second row, and for storage and recharging of the power source modules.

The sensor and power source modules can be adapted for selective coupling to form modular seismic nodes, or autonomous seismic node assemblies. The first set of receptacles may have a geometry adapted for coupling in data communication with seismic data stores on the sensor modules, and the second set of receptacles may have a different geometry adapted for coupling in power communication with power sources on the power source modules.

In any of these examples and embodiments, each receptacle in the first set may comprise a first base adapted for affixing to the one of the first set of rack structures, and one, two or more first longitudinal sections extending from the base. The base and longitudinal extensions may be formed of a molded material, for example from a suitable plastic or composite material forming the base and extensions as a unitary body. The longitudinal sections can be adapted to engage with one of the sensor modules; for example, the longitudinal sections may be adapted to extend into respective apertures in the engaged sensor module.

One or more (or each) of the first receptacles may include a connector attached to the base; e.g., a data connector adapted for connecting the sensor modules to a data network, and configured for communication of seismic sensor data stored on the engaged sensor module, via the data network. The connector can be disposed in an aperture in the base, and adapted for coupling with a complementary connector on the engaged sensor module; e.g., when the complementary connector is inserted into or through the aperture.

In any of these examples and embodiments, each receptacle in the second set may comprise a second molded base adapted for affixing to one of the second set of rack structures, and one, two, or more second longitudinal sections extending from the base. The base and longitudinal extensions may be formed of a molded material, for example from a suitable plastic or composite material forming the base and extensions as a unitary body. The longitudinal sections can be configured to engage one of the power source modules; for example, the longitudinal sections may be adapted to engage about respective sections or extensions of the engaged power source module.

One or more (or each) of the second receptacles may include a connector attached to the base; e.g. a power connector adapted for connecting the power source modules to a power network, and configured for charging a power source on the engaged power source module, via the power network. The connector can be disposed in an aperture in the base, and adapted for coupling with a complementary connector on the engaged power source module; e.g., when the complementary connector is inserted into or through the aperture.

A node handling apparatus can be provided with the system, and configured to assemble the sensor modules and power source modules into a modular seismic node. The node handling apparatus can also be configured to disassemble the sensor modules and power source modules from a modular seismic node, or for both assembly and disassembly of the sensor and power source modules.

In any of these examples and embodiments, each receptacle in the first set can adapted for coupling one of the sensor modules to a data network for data retrieval from a seismic data store on the respective sensor module. Each receptacle in the second set can be adapted for coupling one of the power source modules to a power network for recharging a power source on the respective power source module.

Method and process embodiments are provided for operating such a system, and for other seismic node storage and handling operations. For example, a modular seismic node may be disassembled to provide a sensor module having a seismic sensor or seismic data store, or both, and a power module having one or more power sources for the seismic sensor.

The sensor module can be engaged with a first receptacle coupled to a first rack structure; e.g., with the sensor module connected to a data network for retrieving seismic data obtained from the seismic sensor, and stored in the seismic data store. The power module can be engaged with a second receptacle affixed to a second rack structure, with the power module connected to a power network for recharging the power source.

In any of these examples and embodiments, a connector of the sensor module can be inserted into or coupled with a connector in or on the first receptacle; e.g., for retrieving the seismic data obtained from the seismic sensor or data store over the data network, via the connectors. Longitudinal sections extending from a base of the first receptacle can be coupled with or extended into respective apertures in the sensor module; e.g., for securing the sensor module to the first rack structure thereby.

In any of these examples and embodiments, a connector of the power module can be inserted into or coupled with a connector in or on the second receptacle; e.g., for connecting the power module to the power network and charging the power source, via the coupled connectors. Longitudinal sections extending from a base of the second receptacle can be engaged with or about respective sections of the power module' e.g., for securing the power module to the second rack structure thereby.

The sensor module and power source module can be both stored and refurbished, according to both the system and method embodiments. For example, the sensor module can be refurbished by one or more of retrieving the seismic data obtained by the seismic sensor, from the seismic data store, calibrating the seismic sensor, and synchronizing a clock on the sensor module, via the data network. The power module can be refurbished by one or more of charging the power source and testing the power source, via the power network.

Apparatus embodiments encompass variations of the disclosed seismic node storage systems, and are suitable for use according any of the disclosed methods of operation. For example, a node handler can be configured to assemble an autonomous or modular seismic sensor node from a sensor module having a seismic sensor and a power module having a power source for the seismic sensor, or to disassemble the modular node into a sensor module and a power module, or for both assembly and disassembly of a modular seismic node.

A module transporter can be configured to convey the sensor and power module between the node handler and first and second rack structures, respectively. First and second receptacles can be coupled to the first and second rack structures; e.g., with the first and second receptacles adapted to engage the sensor and power modules, respectively, for storage and reconditioning thereof.

Any of these examples and embodiments can include a first connector disposed in or on one or more of the first receptacles, for example connected to molded base member and adapted for connecting the sensor module to a data network for retrieval of seismic sensor data from the sensor module. A second connector cam be disposed in or on one or more of the second receptacles, and adapted for connecting the power module to a power network for recharging a power supply on the power module.

Suitable node handlers can include one or more arms or other structural member adapted for selectively engaging and disengaging the sensor and power modules. An actuator can be adapted for selectively coupling and decoupling the modules; e.g., via a mechanical pin or screw attachment. The module transporter may comprise first and second tracks similar structures extending between the node handler and the first and second rack structures, respectively. For example, the first track can be configured for conveying the sensor modules between the node handle and the first rack structure. The second track can be configured for conveying the power modules between the node handler and the second rack structure. The tracks can transport the modules in either direction; e.g., for assembly of the sensor and power modules and deployment of the assembled nodes, or for disassembly of the node assemblies for storage and refurbishing and reconditioning of the sensor and power modules.

While this disclosure is directed to representative embodiments, other examples may be encompassed without departing from the scope of invention, as determined by the claims. While the invention may be described with respect to particular exemplary embodiments, it is understood that changes can be made and equivalents may be substituted to adapt the disclosure to different problems and application, while remaining within the spirit and scope of the invention as claimed. The invention is not limited to the particular examples that are described, but encompasses all embodiments falling within the scope of the claims.

1. An automated storage system for seismic nodes, the system comprising:
a modular housing assembly with a first row of rack structures, and a second row of rack structures;
a first receptacle configured to couple a sensor module of a seismic node to a rack structure of the first row of rack structures, the first receptacle adapted for storage of and data communication with the sensor module; and
a second receptacle configured to couple a power source module of the seismic node to a rack structure of the second row of rack structures, the second receptacle adapted for storage and recharging of the power source module.

2. The system of claim 1, wherein the sensor module and power source module are adapted for selective coupling to form the seismic nodes, with the first receptacle having a geometry adapted for coupling in data communication with seismic data stores on the sensor module and the second receptacle having a different geometry adapted for coupling in power communication with a power source on the power source module.

3. The system of claim 1, wherein the first receptacle comprises a base adapted for affixing to the rack structure of the first row of rack structures and engaging with the sensor module, and further comprising a connector configured for retrieval of seismic sensor data stored on the engaged sensor module, via the data communication.

4. The system of claim 3, wherein the base is formed of a molded material and includes a longitudinal sections extending therefrom, the longitudinal section adapted for insertion into a respective aperture in the engaged sensor module.

5. The system of claim 3, wherein the connector is disposed in an aperture in the base and adapted for coupling with a complementary connector on the engaged sensor module, with the complementary connector inserted into the aperture.

6. The system of claim 1, wherein the second receptacle comprises a base adapted for affixing to rack structure of the second row of rack structures and engaging with the power source module, and further comprising a connector configured for charging a power source on the engaged power source module, via the power communication.

7. The system of claim 6, wherein the base is formed of a molded material and includes a longitudinal section extending from the base, the longitudinal section configured to engage about a respective section of the engaged power source module.

8. The system of claim 6, wherein the connector is disposed in an aperture in the base and adapted for coupling with a complementary connector on the engaged power source module, with the complementary connector inserted into the aperture.

9. The system of claim 1, further comprising a node handling apparatus configured to assemble the sensor module and the power source module into the seismic node, to disassemble the sensor module and the power source modules from the seismic node, or combinations thereof.

10. The system of claim 1, wherein the first receptacle is adapted for coupling the sensor module to a data network for retrieval of seismic data, and wherein the second set is adapted for coupling the power source module to a power network for recharging a power source on the power source module.

11. A method for storing a modular seismic node, the method comprising:
disassembling a modular seismic node to provide a sensor module having a seismic sensor and a power module having a power source for the seismic sensor;
engaging the sensor module with a first receptacle coupled to a first rack structure, wherein the sensor module is connected to a data network for retrieving seismic data obtained from the seismic sensor; and
engaging the power module with a second receptacle affixed to a second rack structure, wherein the power module is connected to a power network for recharging the power source.

12. The method of claim 11, further comprising:
coupling a connector of the sensor module with a connector in or on the first receptacle; and
retrieving the seismic data obtained from the seismic sensor over the data network, via the coupled connectors.

13. The method of claim 12, further comprising inserting a longitudinal section extending from a base of the first receptacle into a respective aperture in the sensor module to secure the sensor module to the first rack structure.

14. The method of claim 11, further comprising coupling a connector of the power module with a connector in or on the second receptacle, and charging the power source with the power network, via the coupled connectors.

15. The method of claim 14, further comprising engaging a longitudinal section extending from a base of the second receptacle about a respective section of the power module to secure the power module to the second rack structure.

16. The method of claim 11, further comprising one or more of:
calibrating the seismic sensor and synchronizing a clock on the sensor module, via the data network; and
testing the power source on the power module, via the power network.

17. An apparatus comprising:
a node handler configured to disassemble a modular seismic node into a sensor module having a seismic sensor and a power module having a power source for the seismic sensor;
a module transporter configured to convey the sensor module and the power module between the node handler and a first rack structure and a second rack structure, respectively; and
a first receptacle and a second receptacle coupled to the first rack structure and a second rack structure, respectively, the first receptacle and the second receptacle adapted to engage the sensor module and the power module, respectively, for storage and reconditioning thereof.

18. The apparatus of claim 17, further comprising one or more of:
a first connector disposed in or on the first receptacle and adapted for connecting the sensor module to a data network for retrieval of seismic sensor data from the sensor module; and
a second connector disposed in or on the second receptacle and adapted for connecting the power module to a power network for recharging a power supply on the power module.

19. The apparatus of claim 17, wherein the node handler comprises an arm or structural member adapted for selectively engaging and disengaging the sensor module or the power module, and an actuator adapted for selectively coupling and decoupling the sensor module or the power module via a mechanical pin or screw attachment.

20. The apparatus of claim 19, wherein the module transporter comprises a first track and a second track extending between the node handler and the first rack structure and the second rack structure, respectively, the first track configured for conveying the sensor module and the second track configured for conveying the power module.
